(19) United States
(12) Patent Application Publication
(10) Pub. No.: US 2018/0191220 A1
(43) Pub. Date: Jul. 5, 2018

(54) ELECTRIC COMPRESSOR

(71) Applicant: KABUSHIKI KAISHA TOYOTA JIDOSHOKKI, Kariya-shi, Aichi-ken (JP)

(72) Inventors: Naoki KATO, Kariya-shi (JP); Shogo MORI, Kariya-shi (JP); Yuri OTOBE, Kariya-shi (JP); Hiroshi YUGUCHI, Kariya-shi (JP); Yusuke KINOSHITA, Kariya-shi (JP)

(73) Assignee: KABUSHIKI KAISHA TOYOTA JIDOSHOKKI, Kariya-shi, Aichi-ken (JP)

(21) Appl. No.: 15/740,159

(22) PCT Filed: Jun. 23, 2016
(86) PCT No.: PCT/JP2016/068604

§ 371 Date: Dec. 27, 2017

(30) Foreign Application Priority Data
Jun. 30, 2015 (JP) 2015-132212
Apr. 12, 2016 (JP) 2016-079401

(51) Int. Cl. H02K 5/20; F04C 29/00; H02K 5/22; H02K 7/14; H02K 9/04; H02K 11/33

(52) U.S. Cl. CPC H02K 5/20; F04C 29/0085; H02K 5/225; H02M 7/003; H02K 9/04; H02K 11/33; H02K 2209/00; H02K 7/14

(57) ABSTRACT

A motor-driven compressor includes a compressor unit, a motor unit including a motor, and an inverter unit that drives the motor. The compressor unit, the motor unit, and the inverter unit are lined up in an axial direction of the motor. The motor-driven compressor further includes a housing that accommodates the compressor unit and the motor unit. The inverter unit includes an inverter module. The inverter module includes U-phase, V-phase, and W-phase semiconductor elements that respectively configure U-phase, V-phase, and W-phase arms and a substrate on which the semiconductor elements are bare-chip-mounted. The substrate includes a heat dissipation surface that is thermally connected to the housing. The semiconductor elements are arranged along a contour of the housing.

### TECHNICAL FIELD

The present invention relates to a motor-driven compressor.

### BACKGROUND ART

Patent document 1 describes an example of a motor-driven compressor including a compressor unit, a motor unit, and an inverter unit. The inverter unit includes a plurality of semiconductor elements. In the motor-driven compressor, the semiconductor elements are radially arranged around a drive shaft of a motor in a plane that intersects the drive shaft. Each semiconductor element has a rectangular flat shape. Sectoral gaps are formed between adjacent semiconductor elements.

### PRIOR ART DOCUMENT

### Patent Document

Patent Document 1: Japanese Laid-Open Patent Publication No. 2010-275951

### SUMMARY OF THE INVENTION

### Problems that are to be Solved by the Invention

There is a demand to further reduce the size of the motor-driven compressor, and the inverter unit that drives the motor needs to be reduced in size. As described in patent document 1, the inverter unit is often circular and shaped in conformance with a housing that accommodates the compressor unit and the motor unit. This enlarges the inverter unit in a circumferential direction. Further, the semiconductor elements of the inverter unit are formed by a plurality of discrete components arranged in an arcuate manner or formed as a rectangular integrated module including a plurality of wired discrete components. The arrangement of the discrete components in an arcuate manner or the formation of the rectangular integrated module enlarges dead space.

It is an object of the present invention to provide a motor-driven compressor that can be reduced in size.

### Means for Solving the Problem

A motor-driven compressor that solves the above problem includes a compressor unit, a motor unit including a motor, and an inverter unit that drives the motor. The compressor unit, the motor unit, and the inverter unit are lined up in an axial direction of the motor. The motor-driven compressor further includes a housing that accommodates the compressor unit and the motor unit. The inverter unit includes an inverter module. The inverter module includes U-phase, V-phase, and W-phase semiconductor elements that respectively configure U-phase, V-phase, and W-phase arms and a substrate on which the semiconductor elements are bare-chip-mounted. The substrate includes a heat dissipation surface that is thermally connected to the housing. The semiconductor elements are arranged along a contour of the housing.

### BRIEF DESCRIPTION OF THE DRAWINGS

FIG. 1 is a cutaway side view showing part of a motor-driven compressor.

FIG. 2 is a cross-sectional view taken along line 2-2 in FIG. 1.

FIG. 3 is a plan view showing an inverter module of the motor-driven compressor of FIG. 1.

FIG. 4 is a front view showing the inverter module of FIG. 3.

FIG. 5A is a plan view showing the inverter module of FIG. 3 without a case, bus bars, and the like.

FIG. 5B is a front view showing the inverter module of FIG. 3 without the case, the bus bars, and the like.

FIG. 6 is a diagram illustrating the arrangement of elements in the inverter module of FIG. 3.

FIG. 7 is a circuit diagram showing the electrical configuration of an inverter of the motor-driven compressor shown in FIG. 1.

### EMBODIMENTS OF THE INVENTION

One embodiment of the present invention will now be described with reference to the drawings.

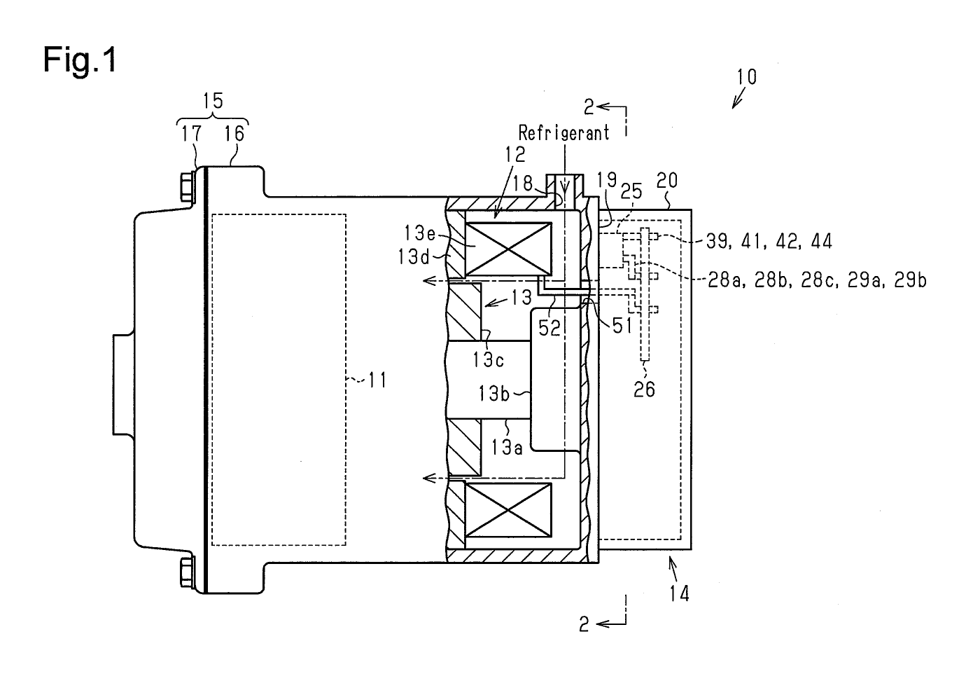

As shown in FIG. 1, an on-board motor-driven compressor 10 includes a compressor unit 11, a motor unit 12 having a motor 13, and an inverter unit 14 that drives the motor 13. The compressor unit 11, the motor unit 12, and the inverter unit 14 are lined up in an axial direction of the motor 13. The motor 13 is, for example, a three-phase AC motor. The motor-driven compressor 10 includes a housing 15. The compressor unit 11 and the motor unit 12 are accommodated in the housing 15.

The housing 15 includes a tubular first housing 16 having a closed end and a tubular second housing 17 having a lid. The second housing 17 is joined with an open end of the first housing 16. The first housing 16 and the second housing 17 are formed from an aluminum material. The housing 15 is formed by coupling the first housing 16 to the second housing 17. The first housing 16 includes an inlet 18 through which refrigerant flows into the first housing 16. The inlet 18 extends through the first housing 16 from an outer-diameter side of the first housing 16 to an inner-diameter side of the first housing 16. The motor-driven compressor inverter unit 14 is integrated with the compressor unit 11. Thus, an inverter module 25 of the inverter unit 14 is arranged near the inlet 18 to cool the inverter module 25 with the refrigerant. The first housing 16 accommodates the compressor unit 11 that compresses the refrigerant and the motor unit 12 that drives the compressor unit 11.

The motor 13 includes a shaft 13a. A bearing in a bearing box 13b rotationally supports the shaft 13a. Further, the motor 13 includes a rotor 13c fixed to the shaft 13a and a stator 13d fixed to the first housing 16 at an outer circumferential side of the rotor 13c. A coil wound around a stator core of the stator 13d includes a coil end 13e that projects from the stator core in the axial direction.

The inverter unit 14 that drives the motor 13 is arranged on an axial outer surface 19 of the first housing 16 (axial end surface of first housing 16). The inverter unit 14 is covered by a cover 20 arranged on the outer surface 19 of the first housing 16. The outer surface 19 is a flat surface.

As shown in FIG. 7, the inverter unit 14 includes an inverter circuit 21 and an inverter control device 22. The inverter control device 22 includes a controller 23.

The inverter circuit 21 includes six semiconductor switching elements Q1 to Q6 and six diodes D1 to D6. An IGBT is used as each of the semiconductor switching elements Q1 to Q6. The semiconductor switching element Q1 configuring a U-phase upper arm and the semiconductor switching element Q2 configuring a U-phase lower arm are connected in series between a positive electrode bus bar and a negative electrode bus bar. The semiconductor switching element Q3 configuring a V-phase upper arm and the semiconductor switching element Q4 configuring a V-phase lower arm are connected in series between the positive electrode bus bar and the negative electrode bus bar. The semiconductor switching element Q5 configuring a W-phase upper arm and the semiconductor switching element Q6 configuring a W-phase lower arm are connected in series between the positive electrode bus bar and the negative electrode bus bar. The diodes D1 to D6 are connected in antiparallel to the semiconductor switching elements Q1 to Q6, respectively. An on-board battery 24 serving as a DC power supply is connected to the positive electrode bus bar and the negative electrode bus bar.

A U-phase terminal of the motor 13 is connected between the semiconductor switching element Q1 and the semiconductor switching element Q2. A V-phase terminal of the motor 13 is connected between the semiconductor switching element Q3 and the semiconductor switching element Q4. A W-phase terminal of the motor 13 is connected between the semiconductor switching element Q5 and the semiconductor switching element Q6. When the semiconductor switching elements Q1 to Q6 perform switching operations, the inverter circuit 21 including the semiconductor switching elements Q1 to Q6 that configure the upper and lower arms convert DC voltage, which is the voltage at the battery 24, into AC voltage and supply the AC voltage to the motor 13.

The controller 23 is connected to the gate terminal of each of the semiconductor switching elements Q1 to Q6. The controller 23 performs switching operations with the semiconductor switching elements Q1 to Q6. More specifically, the inverter circuit 21, which includes the semiconductor switching elements Q1 to Q6 configuring the U-phase, V-phase, and W-phase upper and lower arms, performs the switching operations with the semiconductor switching elements Q1 to Q6 to convert the direct current supplied from the battery 24 to three-phase alternating current having a suitable frequency and supply the three-phase alternating current to a coil for each phase of the motor 13. In other words, the switching operations of the semiconductor switching elements Q1 to Q6 energize the coil of each phase of the motor 13 and drive the motor 13.

A shunt resistor Rs1 used to detect current is connected between the semiconductor switching element Q2 and the negative electrode bus bar. A shunt resistor Rs2 used to detect current is connected between the semiconductor switching element Q4 and the negative electrode bus bar. A shunt resistor Rs3 used to detect current is connected between the semiconductor switching element Q6 and the negative electrode bus bar.

The controller 23 detects voltage across two ends of the shunt resistor Rs1. The controller 23 detects voltage across two ends of the shunt resistor Rs2. The controller 23 detects voltage across two ends of the shunt resistor Rs3. The controller 23 detects U-phase current, V-phase current, and W-phase current from the voltage at the two ends of each shunt resistor detected in such a manner for reflection on control of the semiconductor switching elements Q1 to Q6.

The structure of the inverter unit 14 will now be described.

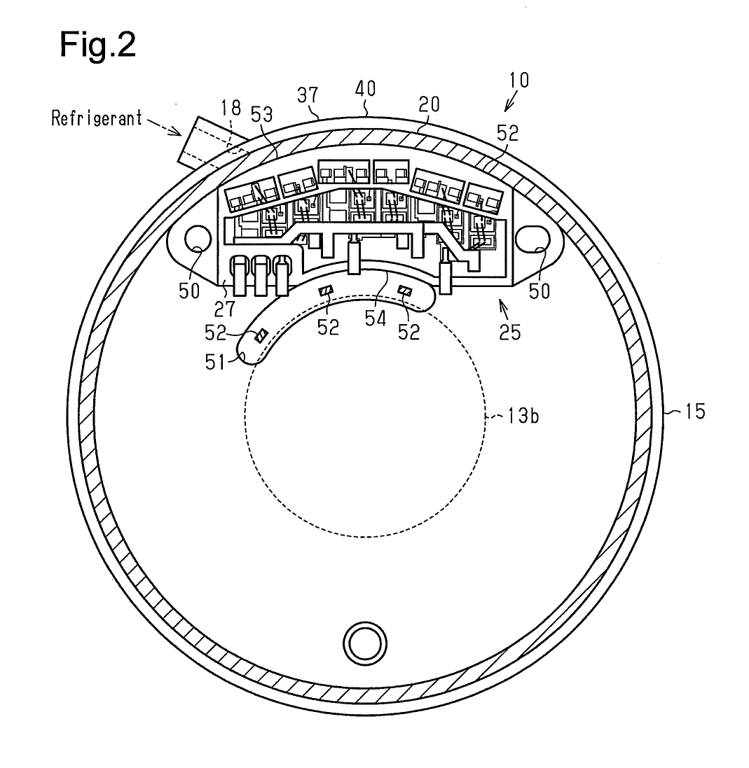

As shown in FIG. 1, the inverter unit 14 includes the inverter module 25 and a control board 26 (for example, printed circuit board). As shown in FIGS. 1 and 2, the inverter module 25 and the control board 26 are covered by the cover 20. The cover 20 also accommodates, for example, coils and capacitors.

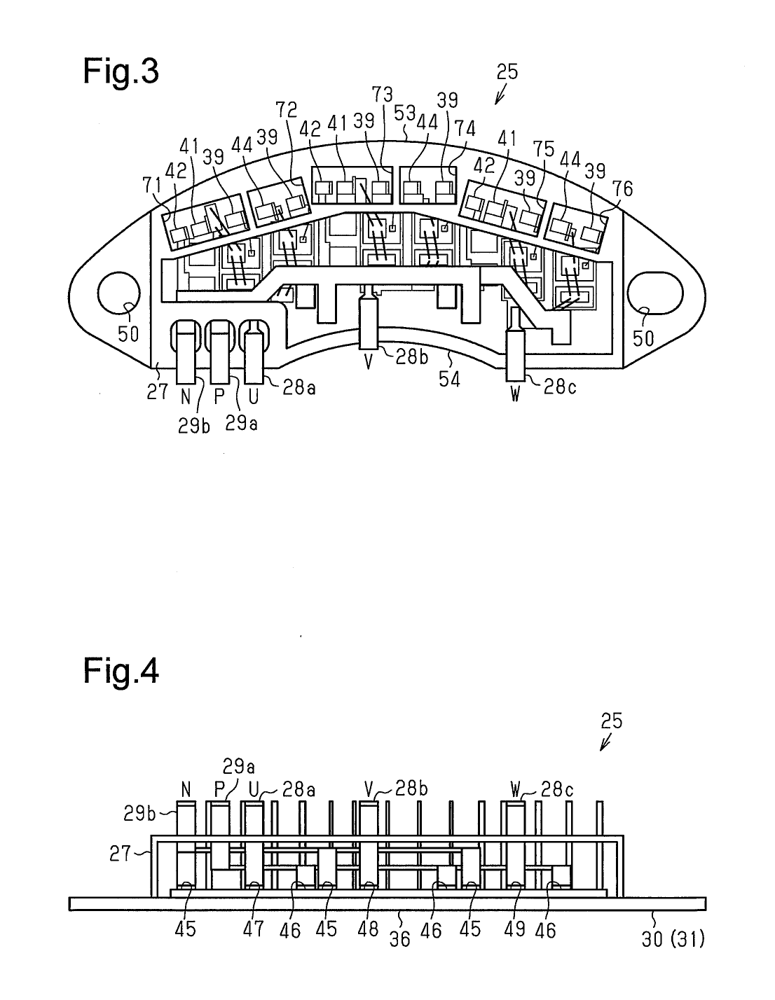

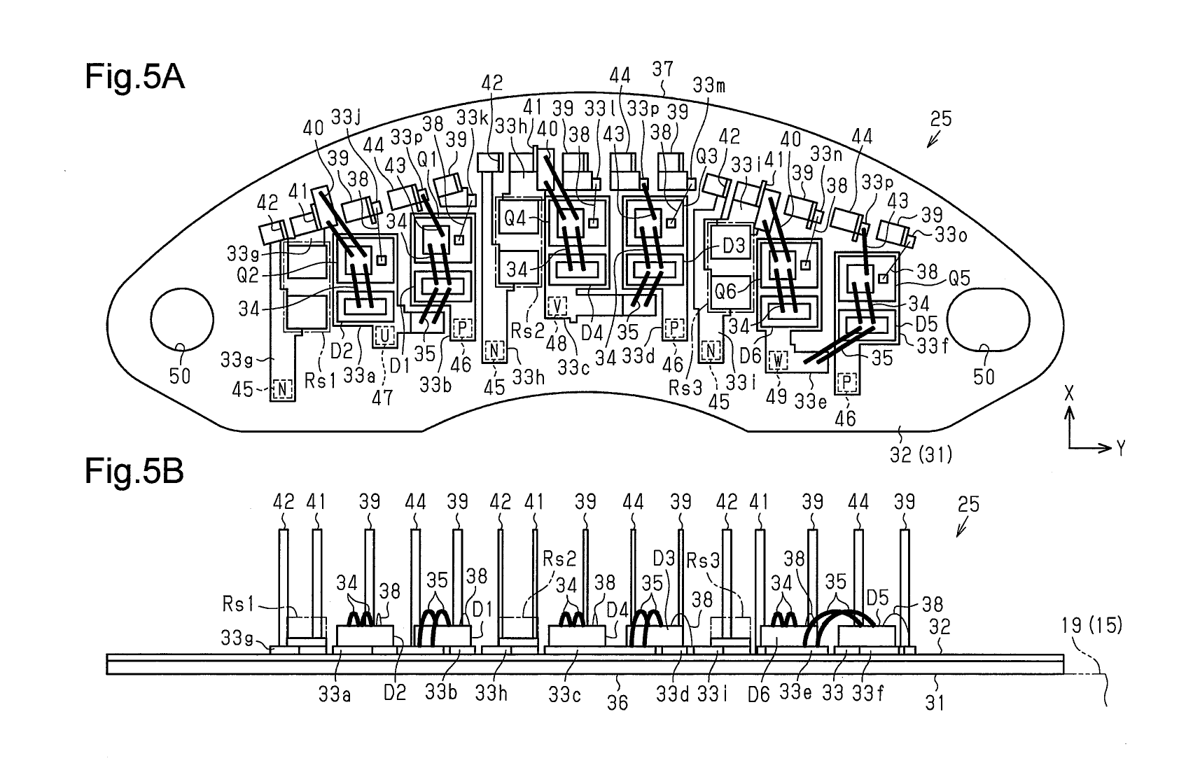

As shown in FIGS. 3 and 4, the inverter module 25 includes a case 27, a U-phase wiring bus bar 28a, a V-phase wiring bus bar 28b, a W-phase wiring bus bar 28c, a positive electrode bus bar 29a, and a negative electrode bus bar 29b. FIGS. 5A and 5B show the inverter module 25 without the case 27, the bus bars 28a, 28b, 28c, 29a, and 29b, and an encapsulating resin (not shown).

As shown in FIGS. 5A and 5B, the inverter module 25 includes an insulated metal substrate (IMS) configured by a metal plate 31, which is formed from copper, and an insulative layer 32, which is formed on an upper surface of the metal plate 31. A plurality of conductor patterns 33 (33a to 33p) formed from copper are formed on the upper surface of the metal plate 31 with the insulative layer 32 located in between. The insulated metal substrate (metal plate 31 and insulative layer 32) has a sectoral shape.

A collector electrode on a lower surface of the semiconductor switching element (chip) Q2 and a cathode electrode on a lower surface of the diode (chip) D2 are soldered to the conductor pattern 33a among the conductor patterns 33. The conductor pattern 33b among the conductors 33 is formed at the right side of the conductor pattern 33a, and a collector electrode on a lower surface of the semiconductor switching element (chip) Q1 and a cathode electrode on a lower surface of the diode (chip) D1 are soldered to the conductor pattern 33b. The conductor pattern 33c among the conductors 33 is formed at the right side of the conductor pattern 33b, and a collector electrode on a lower surface of the semiconductor switching element (chip) Q4 and a cathode electrode on a lower surface of the diode (chip) D4 are soldered to the conductor pattern 33c. The conductor pattern 33d among the conductors 33 is formed at the right side of the conductor pattern 33c, and a collector electrode on a lower surface of the semiconductor switching element (chip) Q3 and a cathode electrode on a lower surface of the diode (chip) D3 are soldered to the conductor pattern 33d. The conductor pattern 33e among the conductors 33 is formed at the right side of the conductor pattern 33d, and a collector electrode on a lower surface of the semiconductor switching element (chip) Q6 and a cathode electrode on a lower surface of the diode (chip) D6 are soldered to the conductor pattern 33e. The conductor pattern 33f among the conductors 33 is formed at the right side of the conductor pattern 33e, and a collector electrode on a lower surface of the semiconductor switching element (chip) Q5 and a cathode electrode on a lower surface of the diode (chip) D5 are soldered to the conductor pattern 33f. The semiconductor switching elements Q1 to Q6 are arranged on the outer circumferential side, and the diodes D1 to D6 are arranged on the inner circumferential side.

Further, an emitter electrode on an upper surface of the semiconductor switching element Q1 and an anode electrode on an upper surface of the diode D1 are electrically connected by bonding wires 34, and an emitter electrode on an upper surface of the semiconductor switching element Q2 and an anode electrode on an upper surface of the diode D2 are electrically connected by bonding wires 34. In the same manner, an emitter electrode on an upper surface of the semiconductor switching element Q3 and an anode electrode on an upper surface of the diode D3 are electrically connected by bonding wires 34, and an emitter electrode on an upper surface of the semiconductor switching element Q4 and an anode electrode on an upper surface of the diode D4 are electrically connected by bonding wires 34. Further, an emitter electrode on an upper surface of the semiconductor switching element Q5 and an anode electrode on an upper surface of the diode D5 are electrically connected by bonding wires 34, and an emitter electrode on an upper surface of the semiconductor switching element Q6 and an anode electrode on an upper surface of the diode D6 are electrically connected by bonding wires 34. The semiconductor switching elements Q1 to Q6 and the diodes D1 to D6 are discrete components. As shown in FIG. 5A, the semiconductor switching elements Q1 to Q6 and the diodes D1 to D6 have a rectangular shape in a plan view.

In this manner, in the inverter module 25, the semiconductor switching elements Q1 to Q6 and the diodes D1 to D6, which form the U-phase, V-phase, and W-phase arms and serve as semiconductor elements, are bare-chip-mounted on the substrate (metal plate 31 and insulative layer 32). When used as single components, the semiconductor switching elements Q1 to Q6 and the diodes D1 to D6 would have to be spaced apart by gaps from one another taking heat resistance into account. However, the module structure of the present embodiment has superior heat dissipation properties. This minimizes the size of the gaps or eliminates the need for forming the gaps.

As shown in FIG. 5A, the anode electrode on the upper surface of the diode D1 and the conductor pattern 33a are electrically connected by bonding wires 35. In the same manner, the anode electrode on the upper surface of the diode D3 and the conductor pattern 33c are electrically connected by bonding wires 35. The anode electrode on the upper surface of the diode D5 and the conductor pattern 33e are electrically connected by bonding wires 35.

Further, as shown in FIG. 5B, a rear surface of the metal plate 31 of the inverter module 25 is a flat surface. The rear surface is a heat dissipating surface 36 of the inverter module 25. The heat dissipating surface 36 is in planar contact with the outer surface 19 of the housing 15. Thus, the heat dissipating surface 36 of the substrate (metal plate 31 and insulative layer 32) of the inverter module 25 is thermally connected to the housing 15.

In addition, as shown in FIG. 2, the housing 15 includes an arcuate contour 37 (outer circumferential surface). The semiconductor switching elements Q1 to Q6 and the diodes D1 to D6 are arranged along the contour 37 of the housing 15.

As shown in FIG. 5A, two conductor patterns 33g are spaced apart from each other at the left side of the U-phase conductor pattern 33a, and an electrode of the shunt resistor (chip resistor) Rs1 is soldered to the two conductor patterns 33g. Two conductor patterns 33h are spaced apart from each other between the U-phase conductor pattern 33b and the V-phase conductor pattern 33c, and an electrode of the shunt resistor (chip resistor) Rs2 is soldered to the two conductor patterns 33h. Two conductor patterns 33i are spaced apart from each other between the V-phase conductor pattern 33d and the W-phase conductor pattern 33e, and an electrode of the shunt resistor (chip resistor) Rs3 is soldered to the two conductor patterns 33i. The shunt resistors Rs1 to Rs3 are discrete components.

As shown in FIG. 5A, the shunt resistor Rs2 is arranged between the U-phase semiconductor elements (semiconductor switching element Q1 and diode D1) and the V-phase semiconductor elements (semiconductor switching element Q4 and diode D4). Further, the shunt resistor Rs3 is arranged between the V-phase semiconductor elements (semiconductor switching element Q3 and diode D3) and the W-phase semiconductor elements (semiconductor switching element Q6 and diode D6). That is, in the inverter module 25, a shunt resistor is arranged between the semiconductor elements (semiconductor switching elements and diodes) of two phases among the U-phase, the V-phase, and the W-phase. In other words, the shunt resistors Rs1 to Rs3 are arranged adjacent to one another in a circumferential direction, not in a radial direction, with respect to the semiconductor switching elements Q1 to Q6 and the diodes D1 to D6. The shunt resistors Rs1 to Rs3 are heat-generating elements. The shunt resistors Rs1 to Rs3 are components that generate heat although the amount of generated heat is less than the semiconductor switching elements Q1 to Q6 and the diodes D1 to D6. The arrangement of the semiconductor elements (semiconductor switching elements and diodes) of two different phases at opposite sides of each of the shunt resistors Rs2 and Rs3 reduces thermal interference between the heat-generating components (semiconductor switching elements Q1 to Q6 and diodes D1 to D6).

As shown in FIG. 5A, the conductor pattern 33j is formed on the outer circumferential side of the conductor pattern 33a, and the conductor pattern 33j and a gate electrode of the semiconductor switching element Q2 are electrically connected by a bonding wire 38. A control terminal 39 serving as a signal terminal is arranged on the conductor pattern 33j. In the same manner, the conductor pattern 33k is formed on the outer circumferential side of the conductor pattern 33b, and the conductor pattern 33k and a gate electrode of the semiconductor switching element Q1 are electrically connected by a bonding wire 38. A control terminal 39 serving as a signal terminal is arranged on the conductor pattern 33k. The conductor pattern 33l is formed on the outer circumferential side of the conductor pattern 33c, and the conductor pattern 33l and a gate electrode of the semiconductor switching element Q4 are electrically connected by a bonding wire 38. A control terminal 39 serving as a signal terminal is arranged on the conductor pattern 33l. The conductor pattern 33m is formed on the outer circumferential side of the conductor pattern 33d, and the conductor pattern 33m and a gate electrode of the semiconductor switching element Q3 are electrically connected by a bonding wire 38. A control terminal 39 serving as a signal terminal is arranged on the conductor pattern 33m. The conductor pattern 33n is formed on the outer circumferential side of the conductor pattern 33e, and the conductor pattern 33n and a gate electrode of the semiconductor switching element Q6 are electrically connected by a bonding wire 38. A control terminal 39 serving as a signal terminal is arranged on the conductor pattern 33n. The conductor pattern 33o is formed on the outer circumferential side of the conductor pattern 33f, and the conductor pattern 33o and a gate electrode of the semiconductor switching element Q5 are electrically connected by a bonding wire 38. A control terminal 39 serving as a signal terminal is arranged on the conductor pattern 33o.

As shown in FIG. 5A, the conductor pattern 33g, which is connected to a first electrode of the shunt resistor Rs1, is electrically connected to the emitter electrode of the upper surface of the semiconductor switching element Q2 by bonding wires 40. A voltage monitor terminal 41 serving as a signal terminal is arranged on the conductor pattern 33g, and a voltage monitor terminal 42 is arranged on the conductor pattern 33g, which is connected to a second electrode of the shunt resistor Rs1. In the same manner, the conductor pattern 33h, which is connected to a first electrode of the shunt resistor Rs2, is electrically connected to the emitter electrode of the upper surface of the semiconductor switching element Q4 by bonding wires 40. A voltage monitor terminal 41 is arranged on the conductor pattern 33h, and a voltage monitor terminal 42 serving as a signal terminal is arranged on the conductor pattern 33h, which is connected to a second electrode of the shunt resistor Rs2. The conductor pattern 33i, which is connected to a first electrode of the shunt resistor Rs3, is electrically connected to the emitter electrode of the upper surface of the semiconductor switching element Q6 by bonding wires 40. A voltage monitor terminal 41 is arranged on the conductor pattern 33i, and a voltage monitor terminal 42 serving as a signal terminal is arranged on the conductor pattern 33i, which is connected to a second electrode of the shunt resistor Rs3.

Further, the conductor pattern 33p is formed on the outer circumferential side of the conductor pattern 33b, and the conductor pattern 33p and the emitter electrode of the semiconductor switching element Q1 are electrically connected by a bonding wire 43. A signal terminal 44 is arranged on the conductor pattern 33p. In the same manner, the conductor pattern 33p is formed on the outer circumferential side of the conductor pattern 33d, and the conductor pattern 33p and the emitter electrode of the semiconductor switching element Q3 are electrically connected by a bonding wire 43. A signal terminal 44 is arranged on the conductor pattern 33p. The conductor pattern 33p is formed on the outer circumferential side of the conductor pattern 33f, and the conductor pattern 33p and the emitter electrode of the semiconductor switching element Q5 are electrically connected by a bonding wire 43. A signal terminal 44 is arranged on the conductor pattern 33p.

As shown in FIG. 5A, in the inverter module 25, the bonding wires 38, 40, and 43 serving as a plurality of signal wires are lined up next to one another on the outer circumferential side of the housing 15. Further, a plurality of signal terminals (39, 41, 42, and 44) of each phase of the U-phase, the V-phase, and the W-phase are lined up straight next to one another on the outer circumferential side.

As shown in FIG. 5A, the conductor pattern 33g, which is connected to the second electrode of the shunt resistor Rs1, includes a pad 45. In the same manner, the conductor pattern 33h, which is connected to the second electrode of the shunt resistor Rs2, includes a pad 45. The conductor pattern 33i, which is connected to the second electrode of the shunt resistor Rs3, includes a pad 45. As shown in FIGS. 3 and 4, the three pads 45 are electrically connected to one another by the bus bar 29b. The bus bar 29b extends upwardly and includes an end that is a negative electrode terminal.

As shown in FIG. 5A, the conductor pattern 33b includes a pad 46. In the same manner, the conductor pattern 33d includes a pad 46. The conductor pattern 33f includes a pad 46. As shown in FIGS. 3 and 4, the three pads 46 are electrically connected by the bus bar 29a. The bus bar 29a extends upwardly and includes an end that is a positive electrode terminal.

As shown in FIG. 5A, the conductor pattern 33a includes a pad 47. As shown in FIGS. 3 and 4, the bus bar 28a includes one end joined with the pad 47 and another end that is a U-phase terminal and extends upwardly from the pad 47. As shown in FIG. 5A, the conductor pattern 33c includes a pad 48. As shown in FIGS. 3 and 4, the bus bar 28b includes one end joined with the pad 48 and another end that is a V-phase terminal and extends upwardly from the pad 48. As shown in FIG. 5A, the conductor pattern 33e includes a pad 49. As shown in FIGS. 3 and 4, the bus bar 28c includes one end joined with the pad 49 and another end that is a U-phase terminal and extends upwardly from the pad 49.

In this manner, the terminals (terminals of bus bar 28a, 28b, 28c, 29a, and 29b) where a large amount of current flows are arranged on the inner circumferential side.

Each of the elements (semiconductor switching elements Q1 to Q6, diodes D1 to D6, and shunt resistors Rs1 to Rs3) is encapsulated in a resin (not shown). Further, as shown in FIGS. 3 and 4, each of the elements is arranged in the case 27. Fastening through holes 50 extend through two sides of the insulated metal substrate (metal plate 31 and insulative layer 32) of the inverter module 25. Screws are inserted through the fastening through holes 50 and fastened to the housing 15 to fix the inverter module 25 to the housing 15. An upper surface side of the insulated metal substrate (metal plate 31 and insulative layer 32) is covered by the case 27, and a lower surface of the metal plate 31 is exposed.

Further, each of the terminals (control terminal 39, terminals 41, 42, and 44, and terminals of bus bars 28a, 28b, 28c, 29a, and 29b) extends through the case 27. As shown in FIG. 3, the case 27 includes six rectangular windows 71, 72, 73, 74, 75, and 76. Three terminals 39, 41, and 42, which are arranged along the long sides of the rectangular window 71, extend from the rectangular window 71. In the same manner, two terminals 39 and 44, which are arranged along the long sides of the rectangular window 72, extend from the rectangular window 72. The three terminals 39, 41, and 42, which are arranged along the long sides of the rectangular window 73, extend from the rectangular window 73. The two terminals 39 and 44, which are arranged along the long sides of the rectangular window 74, extend from the rectangular window 74. The three terminals 39, 41, and 42, which are arranged along the long sides of the rectangular window 75, extend from the rectangular window 75. The two terminals 39 and 44, which are arranged along the long sides of the rectangular window 76, extend from the rectangular window 76.

As shown in FIG. 1, a through hole 51 extends through part of the housing 15, more specifically, the closed end (end wall) of the first housing 16. The through hole 51 is located at a position corresponding to terminals 52 of the motor 13 and shaped in correspondence with the layout of the terminals 52. That is, a plurality of terminals 52 are arranged in an arcuate manner, and the through hole 51 extends in an arcuate manner. The terminals 52 are extended through the through hole 51 toward the inverter unit 14 and exposed to the inside of the inverter unit 14. A portion between the terminals 52 and a wall surface of the through hole 51 is sealed. That is, the terminals 52 are hermetically sealed terminals. More specifically, as shown in FIG. 1, the terminals 52 (U-phase, V-phase, and W-phase) extend toward the inverter unit 14 in the axial direction passing through the space between the coil end 13e and the bearing box 13b in the radial direction of the motor 13. That is, the terminals 52 extending at the radially inner side of the outer circumference of the housing 15, not conductors located at the outer-diameter side of the housing 15, electrically connect the motor 13 and the inverter unit 14. This reduces the size of the motor-driven compressor 10 in the radial direction.

As shown in FIG. 2, the through hole 51 (three terminals 52) is located at the radially inner side of an inner circumferential surface of the case 27 of the inverter module 25. The through hole 51 extends along an arc having the same radius. As shown in FIG. 2, an outer circumferential surface 53, which is a first surface of the case 27 of the inverter module 25, has an arcuate shape. The contour 37 (outer circumferential surface) extending in the axial direction of the housing 15 has a circular shape. The outer circumferential surface 53 of the case 27 is shaped in correspondence with the contour 37 (outer circumferential surface), that is, circumferential wall, of the housing 15 extending in the axial direction of the motor 13.

Further, an inner circumferential surface 54, which is a second surface of the case 27 of the inverter module 25, has an arcuate shape.

As shown in FIG. 1, refrigerant flows from the inlet 18 into the housing 15. The inlet 18 is located at the radially outer side of the inverter module 25. Further, the inlet 18 is located at a position corresponding to the inverter module 25 (the same position as the inverter module 25) in the circumferential direction. In particular, in the present embodiment, the inlet 18 is formed so that the refrigerant flows in the layout direction of the semiconductor switching elements Q1 to Q6 and the diodes D1 to D4, which are heat-generating components. In other words, the refrigerant flows from the side corresponding to the semiconductor switching element Q2 and the diode D2 toward the side corresponding to the semiconductor switching element Q5 and the diode D5.

As shown in FIG. 1, the terminals 39, 41, 42, and 44 from the inverter module 25 are extended through the control board 26 and soldered to the control board 26. The terminals of the bus bars 28a, 28b, 28c, 29a, and 29b extending from the inverter module 25 and the terminals 52 extending from the motor 13 are electrically connected to the control board 26.

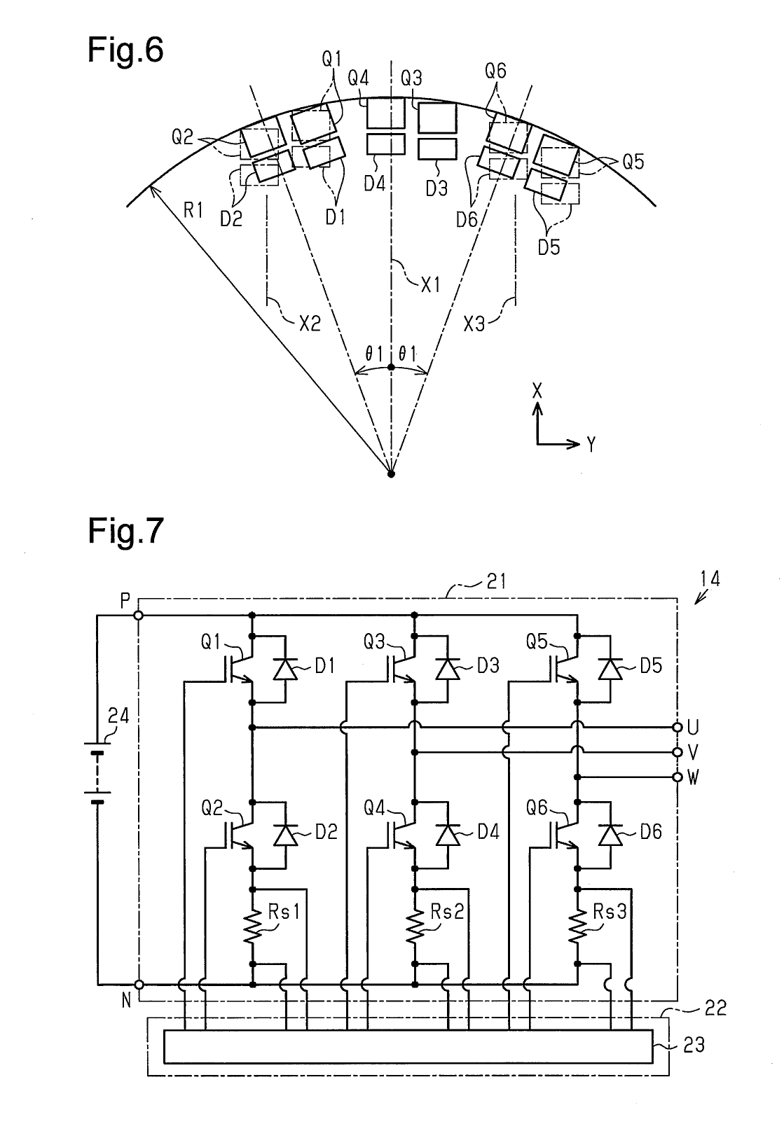

The arrangement of the semiconductor switching elements Q1 to Q6 and the diodes D1 to D6 of the inverter module 25 will now be described with reference to FIG. 6.

As shown in FIG. 6, the semiconductor switching elements Q3 and Q4 are located proximate to each other in a Y-direction. Further, the diode D3 is located at a position proximate to the semiconductor switching element Q3 in an X-direction, and the diode D4 is located at a position proximate to the semiconductor switching element Q4 in the X-direction. The positions of the semiconductor switching elements Q3 and Q4 are set using an X1-axis as a reference. In addition, the upper right corner of the rectangular semiconductor switching element Q3 and the upper left corner of the rectangular semiconductor switching element Q4 lie on the arc having radius R1.

In FIG. 6, the solid lines show the semiconductor switching elements Q1 and Q2 and the diodes D1 and D2 located at positions that would be obtained if the positions of the semiconductor switching elements Q3 and Q4 and the diodes D3 and D4 were to be rotated counterclockwise by a predetermined angle θ1. In order to eliminate dead space, the inclinations of the semiconductor switching elements Q1 and Q2 and the diodes D1 and D2 shown by the solid lines are changed so that the layout direction of the semiconductor switching element Q1 and the diode D1 and the layout direction of the semiconductor switching element Q2 and the diode D2 are parallel to the X1-axis. Further, the semiconductor switching elements Q1 and Q2 and the diodes D1 and D2 are moved in the X-direction so that the upper left corner of the rectangular semiconductor switching element Q2 and the upper left corner of the rectangular semiconductor switching element Q1 lie on the arc having radius R1. The arrangement of the semiconductor switching elements Q1 and Q2 and the diodes D1 and D2 is shown by the broken lines in FIG. 6. This is the arrangement shown in FIG. 5A.

In the same manner, in FIG. 6, the solid lines show the semiconductor switching elements Q5 and Q6 and the diodes D5 and D6 located at positions that would be obtained if the positions of the semiconductor switching elements Q3 and Q4 and the diodes D3 and D4 were to be rotated counterclockwise by a predetermined angle θ1. In order to eliminate dead space, the inclinations of the semiconductor switching elements Q5 and Q6 and the diodes D5 and D6 shown by the solid lines are changed so that the layout direction of the semiconductor switching element Q5 and the diode D5 and the layout direction of the semiconductor switching element Q6 and the diode D6 are parallel to the X1-axis. Further, the semiconductor switching elements Q5 and Q6 and the diodes D5 and D6 are moved in the X-direction so that the upper right corner of the rectangular semiconductor switching element Q5 and the upper right corner of the rectangular semiconductor switching element Q6 lie on the arc having radius R1. The arrangement of the semiconductor switching elements Q5 and Q6 and the diodes D5 and D6 is shown by the broken lines in FIG. 6. This is the arrangement shown in FIG. 5A.

In this manner, the semiconductor switching elements Q1 to Q6 and the diodes D1 to D6 can be arranged along the contour of the housing 15.

The operation will now be described.

As shown in FIGS. 5A and 5B, in the inverter module 25, the semiconductor switching elements Q1 to Q6 and the diodes D1 to D6 are bare-chip-mounted on the substrate (metal plate 31 and insulative layer 32), the heat dissipating surface 36 is thermally connected to the housing 15, and the semiconductor switching elements Q1 to Q6 and the diodes D1 to D6 are arranged along the contour 37 of the housing 15. Such a structure reduces thermal restrictions. Thus, as shown in FIG. 5A, the semiconductor elements can be arranged close to one another in the Y-direction in a state in which the semiconductor switching elements and the diodes are arranged in the X-direction. That is, the distance is reduced between one semiconductor element (semiconductor switching element and diode) and another semiconductor element (semiconductor switching element and diode). Thus, the semiconductor elements can be arranged in a concentrated manner. As a result, the inverter module 25 is reduced in size. This allows other components such as coils to be arranged in the inverter unit 14.

As shown in FIGS. 5A and 5B, the shunt resistor Rs2 is arranged between the set of the semiconductor switching element Q1 and the diode D1 and the set of the semiconductor switching element Q4 and the diode D4. This reduces thermal interference of the U-phase semiconductor elements (semiconductor switching element Q1 and diode D1) with the V-phase semiconductor elements (semiconductor switching element Q4 and diode D4). In addition, the shunt resistor Rs3 is arranged between the set of the semiconductor switching element Q3 and the diode D3 and the set of the semiconductor switching element Q6 and the diode D6. This reduces thermal interference of the V-phase semiconductor elements (semiconductor switching element Q3 and diode D3) with the W-phase semiconductor elements (semiconductor switching element Q6 and diode D6).

Further, the bonding wires 38, 40, and 43 are lined up next to one another on the outer circumferential side of the housing 15. The U-phase signal terminals (39, 41, 42, and 44) are lined up straight next to one another. The V-phase signal terminals (39, 41, 42, and 44) are lined up straight next to one another. The W-phase signal terminals (39, 41, 42, and 44) are lined up straight next to one another. This facilitates the insertion of the signal terminals (39, 41, 42, and 44) of each phase into the through holes of the control board 26.

Additionally, as shown in FIG. 2, the terminals 52 of the motor 13 are extended through the through hole 51 of the housing 15 toward the inverter unit 14 and exposed to the inside of the inverter unit 14. The outer circumferential surface 53 of the case 27 of the inverter module 25 is shaped in correspondence with the outer circumferential surface of the housing 15. Further, the inner circumferential surface 54 of the case 27 extends along the layout of the terminals 52 of the motor 13. In this manner, the inverter module 25 is sectoral and shaped in correspondence with the circular housing 15. This reduces dead space and occupies less space. That is, the inverter module 25 is sectoral to increase the mounting density in the inverter of the motor-driven compressor.

The broken lines in FIG. 1 show the flow of refrigerant. The refrigerant is drawn into the housing 15 from the refrigerant inlet 18. The refrigerant passes through a gap between an outer circumferential surface of the rotor 13c and an inner circumferential surface of the stator 13d in the motor 13 and flows in the axial direction to the compressor unit 11. Further, as the refrigerant drawn from the inlet 18 flows from the radially outer side toward the radially inner side, the refrigerant flows in a region where the inverter module 25 is arranged so that heat exchange is efficiently performed between the refrigerant and the inverter module 25.

The terminals 52 of the motor 13 extend toward the inverter unit 14 through the through hole 51 so that the terminals 52 are exposed to the inside of the inverter unit 14 at the radially inner side of the inverter module 25. The inlet 18 is located at the radially outer side of the inverter module 25. This allows the refrigerant to strike a portion corresponding to where the inverter module 25 is located without being interfered with by the terminals 52 of the motor 13. Thus, the cooling properties of the inverter module 25 are improved.

The above embodiment has the advantages described below.

(1) The motor-driven compressor 10 includes the compressor unit 11, the motor unit 12 including the motor 13, the inverter unit 14 that drives the motor 13, and the housing 15 that accommodates the compressor unit 11 and the motor unit 12. The compressor unit 11, the motor unit 12, and the inverter unit 14 are lined up in the axial direction of the motor 13. The inverter unit 14 includes the inverter module 25. The inverter module 25 includes the U-phase, V-phase, and W-phase semiconductor elements (semiconductor switching elements Q1 to Q6 and diodes D1 to D6) that respectively configure the U-phase, V-phase, and W-phase arms and the substrate (metal plate 31 and insulative layer 32) on which the semiconductor elements are bare-chip-mounted. The substrate (metal plate 31 and insulative layer 32) includes the heat dissipating surface 36, which is thermally connected to the housing 15, and the semiconductor elements (semiconductor switching elements Q1 to Q6 and diodes D1 to D6), which are arranged along the contour 37 of the housing 15. Thus, the U-phase, V-phase, and W-phase semiconductor elements are bare-chip-mounted on the substrate (metal plate 31 and insulative layer 32), and the heat dissipating surface 36 of the inverter module 25 is thermally connected to the housing 15. This reduces thermal restriction and narrows the distance between one semiconductor element (semiconductor switching element and diode) and another semiconductor element (semiconductor switching element and diode). Thus, the semiconductor elements can be arranged in a concentrated manner.

(2) The inverter module 25 includes the shunt resistors Rs2 and Rs3 arranged between the semiconductor elements (semiconductor switching elements Q1 to Q6 and diodes D1 to D6) of two phases among the U-phase, the V-phase, and the W-phase. This reduces thermal interference of the U-phase semiconductor elements (semiconductor switching elements Q1 and Q2 and diodes D1 and D2) with the V-phase semiconductor elements (semiconductor switching elements Q3 and Q4 and diodes D3 and D4). Further, this reduces thermal interference of the V-phase semiconductor elements (semiconductor switching elements Q3 and Q4 and diodes D3 and D4) with the W-phase semiconductor elements (semiconductor switching elements Q5 and Q6 and diodes D5 and D6).

(3) The inverter module 25 includes the signal wires (bonding wires 38, 40, and 43) lined up next to one another on the outer circumferential side of the housing 15 and the signal terminals (39, 41, 42, and 44) of each phase of the U-phase, the V-phase, and the W-phase. Further, the signal terminals (39, 41, 42, and 44) of each phase are lined up straight next to one another. This facilitates the insertion of the signal terminals (39, 41, 42, and 44) into the through hole of the control board 26.

(4) The housing 15 includes the through hole 51. The motor 13 includes the terminals 52 extending through the through hole 51 toward the inverter unit 14. The portion between the terminals 52 and the wall surface of the through hole 51 is sealed. The inverter module 25 includes the case 27. The case 27 includes the first surface (outer circumferential surface 53), shaped in correspondence with the portion of the housing 15 extending in the axial direction of the motor 13, and the second surface (inner circumferential surface 54), extending along the layout of the terminals 52. This reduces dead space in the housing 15.

(5) The housing 15 includes the through hole 51 located at the radially inner side of the inverter module 25. The motor 13 includes the terminals 52 extending through the through hole 51 toward the inverter unit 14. The portion between the terminals 52 and the wall surface of the through hole 51 is sealed. Further, the housing 15 includes the inlet 18 through which refrigerant flows into the housing 15. The inlet 18 is located at the radially outer side of the inverter module 25. This allows the refrigerant to strike the portion where the inverter module 25 is located without being interfered with by the terminals 52 of the motor 13.

The embodiment is not limited to the above description. For example, the embodiment may be modified as described below.

The terminals 52 of the motor 13 are connected to the control board 26, and each of the U-phase, V-phase, and W-phase terminals of the inverter module 25 (terminals of bus bars 28a, 28b, and 28c) is connected to the control board 26. Instead, the terminals 52 of the motor 13 and each of the U-phase, V-phase, and W-phase terminals of the inverter module 25 (terminals of bus bars 28a, 28b, and 28c) may be directly joined through resistance welding or the like.

The shunt resistors Rs1, Rs2, and Rs3 do not have to be mounted on the insulated metal substrate (metal plate 31 and insulative layer 32). For example, the shunt resistors Rs1, Rs2, and Rs3 may be modularized as a component separate from the insulated metal substrate without being mounted on the insulated metal substrate (metal plate 31 and insulative layer 32). This is particularly effective when the shunt resistors Rs2 and Rs3 generate a larger amount of heat than the semiconductor switching elements (Q1 to Q6) and the diodes (D1 to D6).

Instead of IGBTs, power MOSFETs having parasitic diodes may be used for the semiconductor switching elements Q1 to Q6 of the inverter circuit. In this case, the arms are formed by power MOSFETs.

As shown in FIG. 3, the signal terminals (39, 41, 42, and 44) are arranged on the outer circumferential side of the sectoral inverter module 25, and the terminals (terminals of bus bars 28a, 28b, 28c, 29a, and 29b) where a large amount of current flows are arranged on the inner circumferential side of the sectoral inverter module 25. Instead, the signal terminals may be arranged on the inner circumferential side of the sectoral inverter module 25, and the signal terminals where a large amount of current flows may be arranged on the outer circumferential side.

The outer surface 19 is a flat surface. However, only the portion of the outer surface 19 that contacts the inverter module 25 needs to be flat, and only the portion of the outer surface 19 that contacts the inverter module 25 needs to be thicker than other portions of the outer surface 19.

Each terminal 52 of the motor 13 may include the through hole 51. That is, there may be a plurality of through holes 51.

1. A motor-driven compressor comprising:
a compressor unit;
a motor unit including a motor;
an inverter unit that drives the motor, wherein the compressor unit, the motor unit, and the inverter unit are lined up in an axial direction of the motor; and
a housing that accommodates the compressor unit and the motor unit, wherein
the inverter unit includes an inverter module, wherein the inverter module includes U-phase, V-phase, and W-phase semiconductor elements that respectively configure U-phase, V-phase, and W-phase arms and a substrate on which the semiconductor elements are bare-chip-mounted,
the substrate includes a heat dissipation surface that is thermally connected to the housing, and
the semiconductor elements are arranged along a contour of the housing.

2. The motor-driven compressor according to claim 1, wherein the inverter module includes a shunt resistor arranged between semiconductor elements of two phases among the U-phase, the V-phase, and the W-phase.

3. The motor-driven compressor according to claim 1, wherein
the inverter module includes a plurality of signal wires lined up next to one another on an outer circumferential side of the housing and a plurality of signal terminals for the phases of the U-phase, the V-phase, and the W-phase, and
the signal terminals of each phase are lined up straight next to one another.

4. The motor-driven compressor according to claim 1, wherein
the housing includes a through hole and the motor includes a plurality of terminals extending through the through hole toward the inverter unit, wherein a portion between the terminals and a wall surface of the through hole is sealed, and
the inverter module includes a case, wherein the case includes a first surface that is shaped in correspondence with a portion of the housing extending in the axial direction of the motor and a second surface that extends along a layout of the terminals.

5. The motor-driven compressor according to claim 4, wherein
the housing includes a circumferential wall that extends in the axial direction of the motor and an end wall that closes one end of the circumferential wall, wherein the through hole is formed in the end wall to extend in an arcuate manner, and
the terminals are arranged in an arcuate manner.

6. The motor-driven compressor according to claim 1, wherein
the housing includes a through hole located at a radially inner side of the inverter module and the motor includes a terminal extending through the through hole toward the inverter unit, wherein a portion between the terminal and a wall surface of the through hole is sealed, and
the housing includes an inlet through which refrigerant flows into the housing, wherein the inlet is located at a radially outer side of the inverter module.
